(19) United States
(12) Patent Application Publication
(10) Pub. No.: US 2019/0128916 A1
(43) Pub. Date: May 2, 2019

(54) MEASUREMENT APPARATUS AND DRIVING APPARATUS

(71) Applicant: CANON KABUSHIKI KAISHA, Tokyo (JP)

(72) Inventors: Takefumi Ota, Nagareyama-shi (JP); Takayuki Uozumi, Utsunomiya-shi (JP)

(21) Appl. No.: 16/171,824

(22) Filed: Oct. 26, 2018

(30) Foreign Application Priority Data
Nov. 1, 2017 (JP) 2017-211936

(51) Int. Cl. G01P 3/36; G01S 17/58

(52) U.S. Cl. CPC G01P 3/366; G01S 17/58

(57) ABSTRACT

The present invention provides a measurement apparatus for measuring a velocity of a measurement object in a moving direction, including an optical system configured to divide each of lights emitted from a light source unit into first light and second light and irradiate the measurement object with the lights such that the first light and the second light overlap to form an interference fringe at different positions in a direction orthogonal to the moving direction in correspondence with wavelengths of the lights, wherein a first wavelength of the first light is different from a second wavelength of the second light, a first detection unit configured to detect the light from the measurement object, and a processing unit configured to obtain the velocity based on a change in an intensity of the light detected by the first detection unit.

### BACKGROUND OF THE INVENTION

### Field of the Invention

The present invention relates to a measurement apparatus for measuring the velocity of a measurement object in a moving direction and a driving apparatus.

### Description of the Related Art

As a noncontact displacement gauge, a speed meter (length measuring meter) that measures the velocity or length of a measurement object in a moving direction has been proposed in Japanese Patent No. 3423396.

In the speed meter disclosed in Japanese Patent No. 3423396, the measurement accuracy of the velocity of the measurement object in the moving direction is determined by the wavelength and the angle of light with which the measurement object is irradiated. In addition, the distance (depth) between the speed meter and the measurement object at which the velocity of the measurement object in the moving direction can be measured is determined by a region in which two lights (light beams) with which the measurement object is irradiated overlap.

Hence, as a method of increasing the depth, there exist a method of increasing the width of light with which the measurement object is irradiated and a method of making the two overlapping lights close to parallel. However, when increasing the width of light with which the measurement object is irradiated, an optical system such as a lens need to be made large, resulting in a bulky apparatus (speed meter). On the other hand, when making the two overlapping lights close to parallel, the velocity resolution of the measurement object in the moving direction lowers.

### SUMMARY OF THE INVENTION

The present invention provides a measurement apparatus advantageous in measuring the velocity of a measurement object in a moving direction.

According to one aspect of the present invention, there is provided a measurement apparatus for measuring a velocity of a measurement object in a moving direction, including an optical system configured to divide each of lights emitted from a light source unit into first light and second light and irradiate the measurement object with the lights such that the first light and the second light overlap to form an interference fringe at different positions in a direction orthogonal to the moving direction in correspondence with wavelengths of the lights, wherein a first wavelength of the first light is different from a second wavelength of the second light, a first detection unit configured to detect the light from the measurement object, and a processing unit configured to obtain the velocity based on a change in an intensity of the light detected by the first detection unit.

Further aspects of the present invention will become apparent from the following description of exemplary embodiments with reference to the attached drawings.

### BRIEF DESCRIPTION OF THE DRAWINGS

FIG. 1 is a schematic view showing the arrangement of a Doppler interferometer.

FIG. 2 is a schematic view showing the arrangement of a measurement apparatus according to the first embodiment.

FIGS. 3A and 3B are graphs showing the intensity and the intensity ratio of light detected by a second detection unit with respect to the distance of a measurement object.

FIGS. 4A and 4B are views for explaining the sixth embodiment.

FIG. 5 is a view for explaining the seventh embodiment.

FIG. 6 is a view for explaining the eighth embodiment.

FIG. 7 is a schematic view showing the arrangement of a measurement apparatus according to the 11th embodiment.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

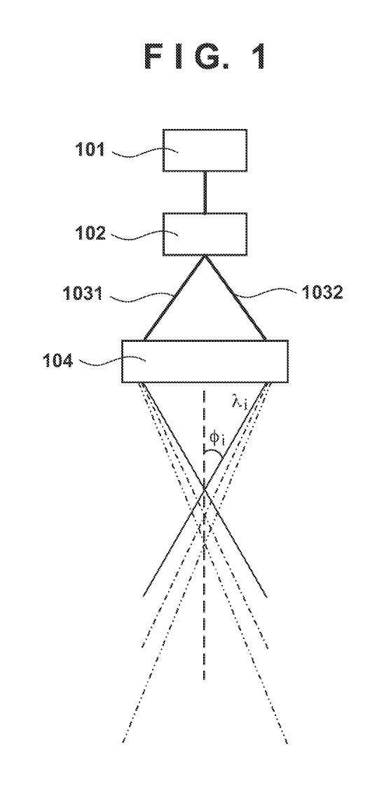

A measurement apparatus according to an aspect of the present invention measures the velocity of a measurement object in a moving direction using the principle of a Doppler interferometer. The principle of a Doppler interferometer will be described first with reference to FIG. 1. FIG. 1 is a schematic view showing the arrangement of a Doppler interferometer.

Referring to FIG. 1, light emitted from a light source 101 is divided into first light 1031 and second light 1032 by a light division element 102. An irradiation optical system 104 irradiates a measurement object with the first light 1031 and the second light 1032 such that the first light 1031 and the second light 1032 overlap at a predetermined position. At the predetermined position, an interference fringe is formed by the overlap of the first light 1031 and the second light 1032.

A velocity V of the measurement object in a moving direction, irradiated with the first light 1031 and the second light 1032, is given by

$$V = \frac{F \cdot λ}{2 \cdot sin ϕ} \qquad ( 1 )$$

where F is the frequency of a change in the intensity of light detected by the Doppler interferometer. In addition, λ is the wavelength of the first light 1031 and the second light 1032 with which the measurement object is irradiated, and ϕ is the irradiation angle of the first light 1031 and the second light 1032 with which the measurement object is irradiated.

Hence, since the intensity of scattered light from the measurement object changes when the measurement object moves on the interference fringe formed by the first light 1031 and the second light 1032, the velocity V of the measurement object in the moving direction can be obtained. In addition, when the velocity V of the measurement object in the moving direction is time-integrated, the displacement, that is, moving amount of the measurement object in the moving direction can be obtained.

The measurement apparatus according to an aspect of the present invention uses a light source unit that emits a plurality of lights having wavelengths different from each other while using the above-described principle of the Doppler interferometer. The plurality of lights emitted from the light source unit overlap at different positions in a direction (distance direction) orthogonal to the moving direction of the measurement object in correspondence with the wavelengths.

If the measurement object exists at a position (region) where first light and second light overlap, the first light (regular reflected light) regularly reflected by the measurement object propagates (passes) through the optical path of the second light in a direction reverse to the second light because the first light and the second light are symmetrical lights. In addition, the second light regularly reflected by the measurement object propagates through the optical path of the first light in a direction reverse to the first light. On the other hand, if the measurement object does not exist at the position where the first light and the second light overlap, the regular reflected light does not propagate through the optical path of the first light or the second light in the reverse direction. It is therefore impossible to detect the light that returns through the optical path.

In the measurement apparatus according to an aspect of the present invention, as described above, the plurality of lights having wavelengths different from each other are made to overlap at different positions in the distance direction in correspondence with the wavelengths. Hence, the depth region in which the first light and the second light overlap expands. Even if the position of the measurement object in the depth direction changes, the measurement object can be located in the region in which the first light and the second light overlap, and the light that returns through the optical path of the first light or the second light can be detected.

Referring to equation (1), to obtain the same velocity for lights of different wavelengths in a case in which the velocity of the measurement object in the moving direction does not change, needs to be satisfied.

$$\frac{{λ}_{i}}{sin {ϕ}_{i}} = a \qquad ( 2 )$$

In equation (2), λᵢ is the wavelength of ith light of the plurality of lights with which the measurement object is irradiated, ϕᵢ is the irradiation angle of the ith light with which the measurement object is irradiated, and a is a constant.

### First Embodiment

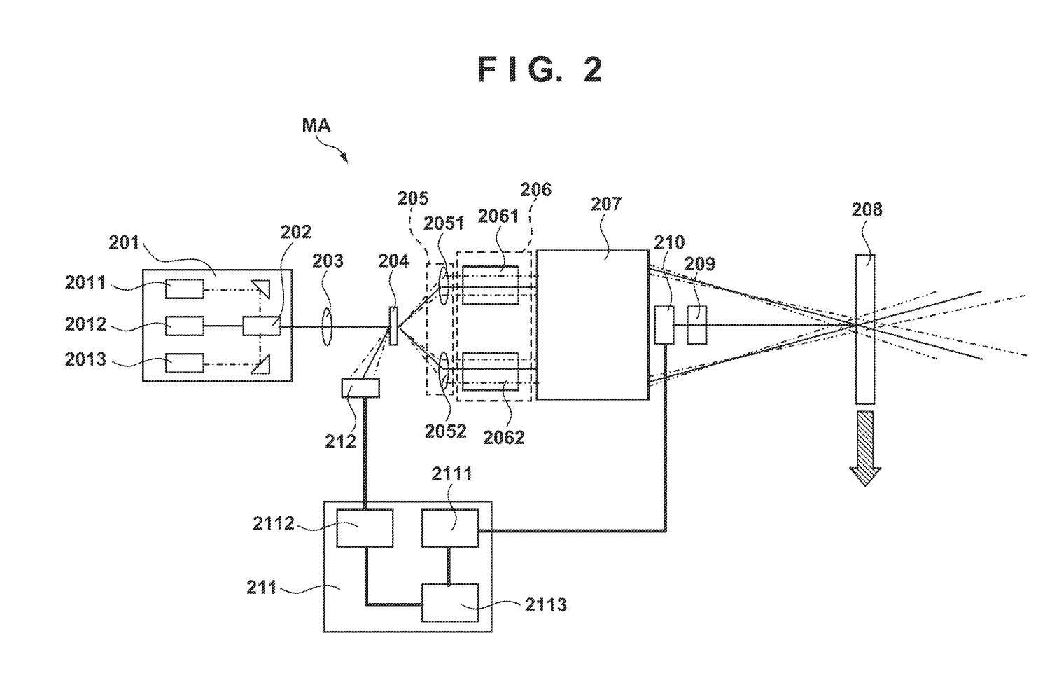

FIG. 2 is a schematic view showing the arrangement of a measurement apparatus MA according to the first embodiment. The measurement apparatus MA measures the velocity of a measurement object 208 in a moving direction MD (to be referred to as “the velocity of the measurement object 208” hereinafter).

The measurement apparatus MA includes a light source unit 201, a collimator lens 203, a light division unit 204, a lens optical system 205, an electrooptic modulation unit 206, an irradiation optical system 207, a detection optical system 209, a first detection unit 210, a processing unit 211, and a second detection unit 212.

The light source unit 201 emits a plurality of lights having wavelengths different from each other. In this embodiment, the light source unit 201 includes a first light source 2011, a second light source 2012, a third light source 2013, and an optical multiplexer 202. In the light source unit 201, light emitted from the first light source 2011, light emitted from the second light source 2012, and light emitted from the third light source 2013 are multiplexed by the optical multiplexer 202 and output. The light emitted from the first light source 2011 has a center wavelength of, for example, 650 nm, the light emitted from the second light source 2012 has a center wavelength of, for example, 500 nm, and the light emitted from the third light source 2013 has a center wavelength of, for example, 400 nm. The optical multiplexer 202 includes a wavelength division multiplexing coupler in this embodiment, but may be replaced with a spatial optical system formed by a dichroic mirror, a grating, a prism, and the like. When such a spatial optical system is used as the optical multiplexer 202 fiber coupling is not needed, contributing to size reduction of the light source unit 201.

The light emitted from the light source unit 201 is converted into parallel light by the collimator lens 203 and divided (branched) into first light and second light by the light division unit 204. The light division unit 204 includes a grating. The pitch of the grating is, for example, 3.2 μm. Since the grating is included, the light division unit 204 divides the incident light into 1st order diffracted light (first light) and −1st order diffracted light (second light), and the division angle changes depending on the wavelength. The light division unit 204 may include a beam splitter in place of the grating. In this case, an optical system that changes irradiation angle in accordance with the wavelength may be formed at the subsequent stage of the light division unit 204. Since this makes it possible to separate division of light and irradiation angle (optical path) control by the wavelength, the degree of freedom of the optical design can be increased.

The lens optical system 205 includes a first lens optical system 2051 and a second lens optical system 2052. The electrooptic modulation unit 206 includes a first electrooptic modulation crystal 2061 and a second electrooptic modulation crystal 2062. The first light and the second light divided by the light division unit 204 enter the lens optical system 205 and are converted via the first lens optical system 2051 and the second lens optical system 2052 into beam shapes to pass through the first electrooptic modulation crystal 2061 and the second electrooptic modulation crystal 2062, respectively. A saw tooth voltage of 200 kHz is applied to the electrooptic modulation crystals to generate a frequency difference between the first light and the second light. Even if the velocity of the measurement object 208 is zero, it is possible to measure that the velocity of the measurement object 208 is zero by detecting the frequency of 200 kHz.

The measurement object 208 is irradiated, via the irradiation optical system 207, with the first light and the second light, which have passed through the electrooptic modulation unit 206. The irradiation optical system 207 irradiates the measurement object 208 with the plurality of lights such that the first light and the second light overlap to form an interference fringe at different positions in a direction (distance direction) orthogonal to the moving direction MD in correspondence with the wavelengths of the plurality of lights emitted from the light source unit 201.

Of the lights from the measurement object 208, light directed to the space between the first light and the second light with which the measurement object is irradiated is detected by the first detection unit 210 via the detection optical system 209 and converted into an electrical signal. The first detection unit 210 includes a photodetector in this embodiment, but is not limited to this. For example, to increase the signal strength, an avalanche photodiode may be used as the first detection unit 210. In addition, the light with which the measurement object 208 is irradiated is not infinitesimal and has a beam spot size. Hence, signals may cancel each other due to the interference of lights scattered from different positions in the beam spot with which the measurement object 208 is irradiated, and it may be necessary to avoid this. Hence, a multi-channel photodiode with a plurality of detection units may be used as the first detection unit 210, and data of channels whose signals do not cancel each other may be used.

The processing unit 211 includes a velocity processing unit 2111, a distance processing unit 2112, and a displacement processing unit 2113. The velocity processing unit 2111 obtains the velocity of the measurement object 208 based on the frequency of the electrical signal output from the first detection unit 210, that is, a change in the intensity of light detected by the first detection unit 210.

In this embodiment, the irradiation optical system 207 irradiates the measurement object 208 with the plurality of lights emitted from the light source unit 201 so as to satisfy equation (2). More specifically, the lights (the first light and the second light) emitted from the first light source 2011 and having a center wavelength of 650 nm have a width of 2 mm each and are made to overlap at an irradiation angle of 7.5° at a distance of 40 mm from the irradiation optical system 207 to form an interference fringe with a period of 2.5 μm. The lights (the first light and the second light) emitted from the second light source 2012 and having a center wavelength of 500 nm have a width of 2 mm each and are made to overlap at an irradiation angle of 5.76° at a distance of 52.2 mm from the irradiation optical system 207 to form an interference fringe with a period of 2.5 μm. The lights (the first light and the second light) emitted from the third light source 2013 and having a center wavelength of 400 nm have a width of 2 mm each and are made to overlap at an irradiation angle of 4.61° at a distance of 65.4 mm from the irradiation optical system 207 to form an interference fringe with a period of 2.5 μm. In this way, the irradiation optical system 207 is configured such that the interference fringes formed at different positions in the distance direction by the lights having the wavelengths different from each other have the same period, that is, satisfy equation (2).

In this embodiment, since the plurality of lights emitted from the light source unit 201 overlap at different positions in the distance direction in accordance with the wavelengths, the distance (depth) between the measurement apparatus MA and the measurement object 208 at which the velocity of the measurement object 208 can be measured can be increased. Accordingly, even if the position of the measurement object 208 relative to the measurement apparatus MA fluctuates due to a fluctuation of the size of the measurement object 208 or a vibration of the measurement object 208, the velocity of the measurement object 208 can stably be measured.

Additionally, in this embodiment, with the apparatus arrangement that satisfies equation (2), the frequency (Doppler frequency) of the change in the intensity of the light detected by the first detection unit 210 is the same with respect to the velocity of the measurement object 208 even for the lights of different wavelengths. However, if the arrangement makes the lights of different wavelengths overlap at different positions in the distance direction, the depth at which the velocity of the measurement object 208 can be measured can be expanded. In this case, although the measurement accuracy of the velocity of the measurement object 208 lowers, the irradiation angle is determined for each wavelength to obtain a desired measurement accuracy.

The measurement apparatus MA according to this embodiment can measure the distance between the measurement apparatus MA and the measurement object 208 (to be referred to as “the distance of the measurement object 208” hereinafter) in the direction (distance direction) orthogonal to the moving direction MD, as will be described below. In addition, the measurement apparatus MA can improve the measurement accuracy of the velocity of the measurement object 208, as will be described below.

Of the lights from the measurement object 208, the light (in this embodiment, the first light that is regularly reflected by the measurement object 208 and propagates through the optical path of the second light in a direction reverse to the second light) that passes through the optical path of the first light or the second light is diffracted by the light division unit 204 (grating). The second detection unit 212 includes a line sensor, detects the light diffracted by the light division unit 204, and acquires the spectrum information of the light. The distance processing unit 2112 obtains the distance of the measurement object 208 by obtaining the peak wavelength of the spectrum based on the spectrum information acquired by the second detection unit 212.

Note that the spectrum information of the light regularly reflected by the measurement object 208 can also be acquired by arranging a beam splitter or the like between the light division unit 204 and the collimator lens 203 and detecting light from the beam splitter via a spectrometer. The spectrum information may be acquired by separating the light using a dichroic mirror or the like and detecting each light by a photodiode without using a grating or a line sensor. When the photodiode is used, high-speed data acquisition can be performed by the compact arrangement.

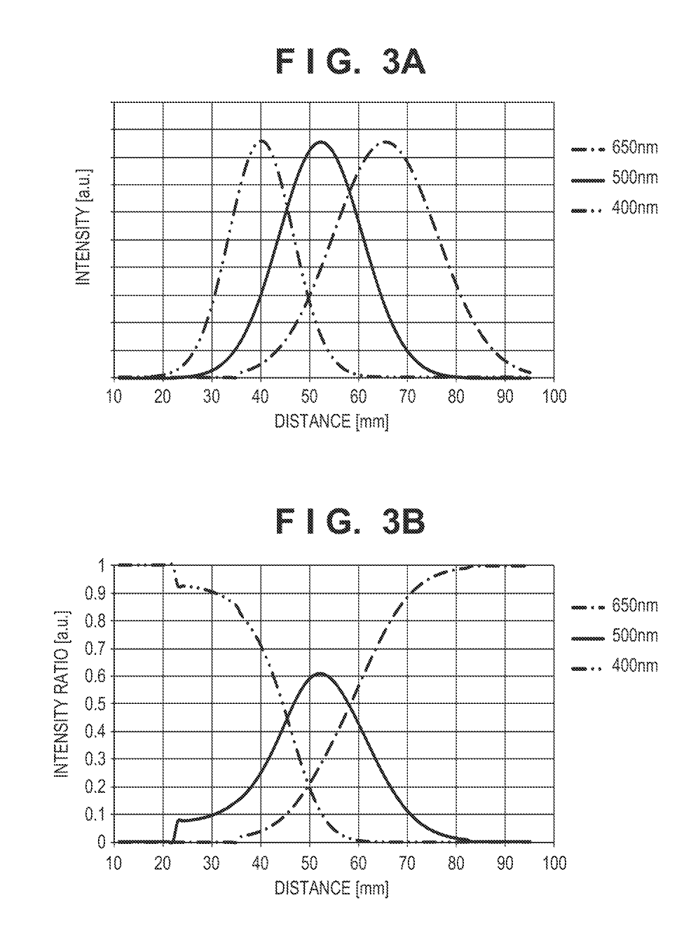

FIG. 3A is a graph showing the intensity of light detected by the second detection unit 212 with respect to the distance of the measurement object 208, and FIG. 3B is a graph showing the intensity ratio of light detected by the second detection unit 212 with respect to the distance of the measurement object 208. When the intensity ratio of the light having the center wavelength of 650 nm, the light having the center wavelength of 500 nm, and the light having the center wavelength of 400 nm is obtained from the spectrum information acquired by the second detection unit 212, the distance of the measurement object 208 can be measured within the range of 20 to 80 mm.

As described above, in the measurement apparatus MA according to this embodiment, since the light source unit 201 that emits a plurality of lights having wavelengths different from each other is used, the distance of the measurement object 208 can be measured in addition to the velocity of the measurement object 208. Note that as for the velocity of the measurement object 208, the irradiation angle is controlled in accordance with the wavelength, as described above, thereby performing predetermined measurement independent of the wavelength.

In addition, when information about the irradiation angle of light of each wavelength is acquired in advance from optical design information of the measurement apparatus MA or the like, the velocity of the measurement object 208 can accurately be obtained based on the intensity of light detected by the first detection unit 210 and the information about the irradiation angle of the light of each wavelength.

In addition, the measurement apparatus MA according to this embodiment can accurately measure a length displacement Δl of the measurement object 208 using a displacement Δz of the measurement object 208 in the distance direction and a displacement Δx of the measurement object 208 in the moving direction. For example, in a case in which the measurement object 208 vibrates in the vertical direction during a movement (or conveyance), the distance of the measurement object 208 is measured as described above, thereby obtaining the displacement Δz of the measurement object 208 in the distance direction. In addition, the velocity of the measurement object 208 is time-integrated, thereby obtaining the displacement Δx of the measurement object 208 in the moving direction. Then, based on the displacement Δz of the measurement object 208 in the distance direction and the displacement Δx of the measurement object 208 in the moving direction, the length displacement Δl of the measurement object 208 can be obtained by

Δl=\sqrt{Δz²+Δx²} (3)

In this embodiment, the pieces of information (the velocity and the distance of the measurement object 208) obtained by the velocity processing unit 2111 and the distance processing unit 2112 are input to the displacement processing unit 2113, and the displacement processing unit 2113 obtains the length displacement Δl of the measurement object 208. In this way, when the information of the measurement object 208 in the distance direction is used, not only the displacement Δx of the measurement object 208 in the moving direction but also the length displacement Δl of the measurement object 208 can accurately be obtained.

Note that in this embodiment, a case in which the processing of obtaining the velocity, distance, and length displacement of the measurement object 208 is performed by the processing unit 211 has been described. However, the present invention is not limited to this. For example, an external information processing apparatus may perform the processing of obtaining the velocity, distance, and length displacement of the measurement object 208. In this case, information about the intensity of light detected by the first detection unit 210 or information about the spectrum of light detected by the second detection unit 212 is transmitted to the external information processing apparatus, and software processing is performed using an application of the information processing apparatus.

### Second Embodiment

In the first embodiment, a case in which the light source unit 201 including the first light source 2011, the second light source 2012, and the third light source 2013 is used has been described. In this embodiment, a wide-band light source configured to emit light that has a spectrum continuously within a wavelength range of 400 nm to 650 nm is used in place of the light source unit 201. Components other than the light source are the same as in the first embodiment.

This embodiment contributes to size reduction and cost reduction of the light source unit, that is, a measurement apparatus MA because it is not necessary to multiplex a plurality of lights having wavelengths different from each other. In addition, since spectrum information can be acquired, the distance of a measurement object 208 can be obtained by obtaining the peak wavelength of the spectrum of light from the measurement object 208.

### Third Embodiment

In this embodiment, a case in which an irradiation optical system 207 does not satisfy equation (2) will be described. A plurality of lights emitted from a light source unit 201 overlap at different positions in the distance direction in correspondence with the wavelengths. Components other than the irradiation optical system are the same as in the first embodiment.

In this embodiment, a processing unit 211 acquires in advance the relationship between the wavelength of each light and an irradiation angle obtained from the optical design and actual measurement, more specifically, a relational expression given by

$$\frac{{λ}_{i}}{sin {ϕ}_{i}} = b ( {λ}_{i} ) \qquad ( 4 )$$

where λᵢ is the wavelength of ith light of a plurality of lights with which the measurement object is irradiated, ϕᵢ is the irradiation angle of the ith light with which the measurement object is irradiated, and b(λᵢ) is a value depending on the wavelength λᵢ.

The processing unit 211 obtains the irradiation angle ϕᵢ based on the spectrum of light (the distance of a measurement object 208) detected by a second detection unit 212 and the relational expression given by equation (4). Then, the processing unit 211 corrects the velocity obtained by a velocity processing unit 2111 using the thus obtained irradiation angle ϕᵢ, thereby improving the measurement accuracy of the velocity of the measurement object 208. As described above, in this embodiment, the velocity of the measurement object 208 obtained based on a change in the intensity of light detected by a first detection unit 210 is corrected based on the relational expression given by equation (4) and the spectrum of light detected by the second detection unit 212.

Since first light and second light divided by a light division unit 204 propagate at different angles in accordance with the wavelengths, lights of different wavelengths propagate to positions that are spatially different. The irradiation optical system 207 according to this embodiment irradiates the measurement object 208 with lights parallelly from different positions on the outermost lens to irradiate the measurement object 208 with lights. The irradiation optical system 207 irradiates the measurement object 208 with the lights of all wavelengths parallelly at the same angle. Here, when the diameter of the lens of the irradiation optical system 207 is 15 mm, and the distance to the measurement object 208 is 50 mm, the irradiation angle is 6°. A frequency F of a change in the intensity of light detected by the first detection unit 210, a wavelength X of light detected by the second detection unit 212, and an irradiation angle ϕ are substituted into equation (1), thereby obtaining a velocity V of the measurement object 208.

According to this embodiment, even for a wavelength that cannot be set by the design of the irradiation optical system 207 and is slightly shifted from equation (2), the shift can be corrected to improve the measurement accuracy of the velocity of the measurement object 208. In addition, since the irradiation optical system specially designed to satisfy equation (2) need not be used, the cost can be reduced.

### Fourth Embodiment

In this embodiment, the spectra of a plurality of lights emitted from a light source unit 201, a loss in each optical system of a measurement apparatus MA, and the wavelength-dependent characteristic of the photoelectric conversion efficiency in a second detection unit 212, that is, the spectrum loss characteristic in the optical path from the light source unit 201 to the second detection unit 212 are acquired. Then, the peak wavelength is specified by normalizing (correcting) the spectrum of light detected by the second detection unit 212 based on the spectra of the plurality of lights emitted from the light source unit 201 and the spectrum loss characteristic, thereby obtaining the distance of a measurement object 208.

As described above, the measurement apparatus MA specifies the wavelength (peak wavelength) of the highest intensity from the spectrum of light detected by the second detection unit 212, thereby obtaining the distance of the measurement object 208. In some cases, however, the light emitted from the light source unit 201 may have a spectrum intensity distribution, or the optical path from the light source unit 201 to the second detection unit 212 may have a spectrum loss characteristic. In this case, a wavelength component of a high spectrum intensity or a wavelength component of a small loss may be detected strongly, and an error may occur when obtaining the distance of the measurement object 208.

Hence, in this embodiment, the peak wavelength is specified by normalizing the spectrum of light detected by the second detection unit 212 based on the spectra of the plurality of lights emitted from the light source unit 201 and the spectrum loss characteristic, thereby implementing accurate measurement of the distance of the measurement object 208. This makes it possible to accurately obtain the distance of the measurement object 208 even when a light source unit, an optical system (optical element), a detection unit, or the like whose intensity or loss changes depending on the wavelength is used. Additionally, in this embodiment, correction for more accurately obtaining the velocity of the measurement object 208 can be performed.

### Fifth Embodiment

In this embodiment, the reflectance characteristic (spectral reflectance) of a measurement object 208 is acquired in advance. The peak wavelength is specified by normalizing (correcting) the spectrum of light detected by a second detection unit 212 based on the reflectance characteristic, thereby obtaining the distance of the measurement object 208.

As described above, a measurement apparatus MA specifies the wavelength (peak wavelength) of the highest intensity from the spectrum of light detected by the second detection unit 212, thereby obtaining the distance of the measurement object 208. However, if the measurement object 208 has a reflectance that changes depending on the wavelength, light of a wavelength other than the wavelength of light with which the position where the measurement object 208 exists is irradiated may be detected strongly, and an error may occur when obtaining the distance of the measurement object 208.

Hence, in this embodiment, the peak wavelength is specified by normalizing the spectrum of light detected by the second detection unit 212 based on the reflectance characteristic of the measurement object 208, thereby implementing accurate measurement of the distance of the measurement object 208. This makes it possible to accurately obtain the distance of the measurement object 208 even when the measurement object 208 has a reflectance that changes depending on the wavelength. Additionally, in this embodiment, correction for more accurately obtaining the velocity of the measurement object 208 can be performed.

### Sixth Embodiment

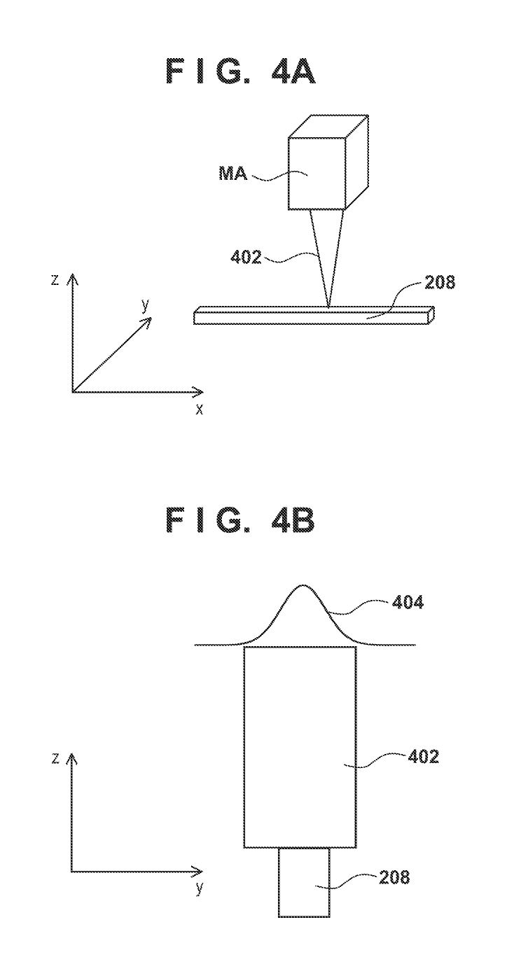

In a case in which a measurement object 208 is narrower than the width (for example, 2 mm) of light emitted from a measurement apparatus MA, or the measurement object 208 is not flat, a length displacement Δl of the measurement object 208 can be obtained by detecting the amount of light from the measurement object 208. In this embodiment, a case in which the measurement object 208 is narrower than the width of light emitted from the measurement apparatus MA, for example, has a cylindrical shape like a thread, a wire, a cable, a steel pipe, or a wide cable will be described with reference to FIGS. 4A and 4B.

As shown in FIG. 4A, lights 402 (first light and second light) emitted from the measurement apparatus MA overlap on the measurement object 208. An intensity distribution 404 of the lights 402 emitted from the measurement apparatus MA has a Gaussian shape, as shown in FIG. 4B. In addition, the measurement object 208 is narrower than the width of the lights 402 emitted from the measurement apparatus MA.

In this case, since the spatial spread (intensity distribution 404) of the lights 402 emitted from the measurement apparatus MA has a single peak, the amount of light reflected by the measurement object 208 is maximized when the measurement object 208 exists at the center position where the lights 402 overlap. In addition, as the measurement object 208 separates from the center position where the lights 402 overlap, the amount of light reflected by the measurement object 208 decreases.

Hence, in this embodiment, the peak intensity (the intensity of the peak wavelength) of the center wavelength of the spectrum of light detected by a second detection unit 212 is obtained, thereby measuring a displacement in a lateral direction (y) perpendicular to the moving direction (x) and the distance direction (z). Accordingly, the displacement of the measurement object 208 in the lateral direction can also be measured in addition to the moving direction and the distance direction. Hence, the length displacement Δl of the measurement object 208 can accurately be obtained based on

Δl=\sqrt{Δz²+Δx²+Δy²} (5)

### Seventh Embodiment

In this embodiment, when the distance between a measurement apparatus MA and a measurement object 208 falls within a predetermined distance range, the velocity of the measurement object 208 is obtained (measured). In addition, the number of times of conveyance of the measurement object 208 into the distance range is counted.

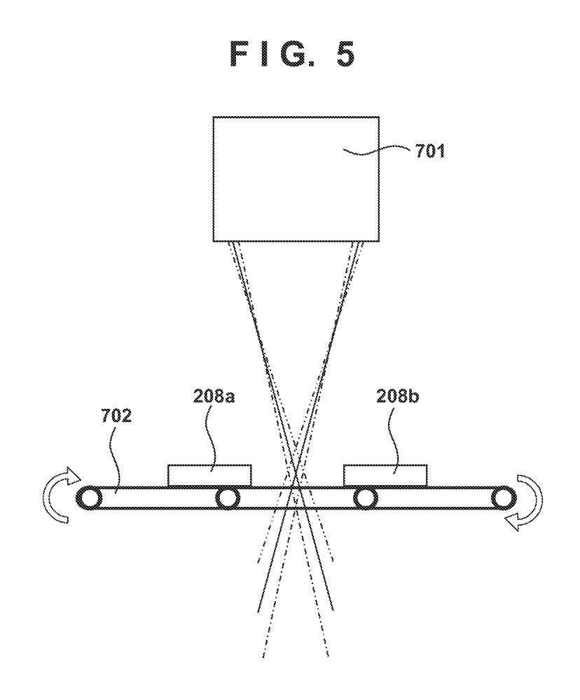

As described above, the depth at which the velocity of the measurement object 208 can be measured by the measurement apparatus MA is 20 to 80 mm. Here, assume a case in which measurement objects 208a and 208b are placed on a conveyance unit 702 such as a belt conveyor and conveyed, as shown in FIG. 5. In this case, even if, for example, a position between the measurement object 208a and the measurement object 208b is irradiated with the light from the measurement apparatus MA, the measurement apparatus MA can measure the velocity of the conveyance unit 702. Hence, the measurement apparatus MA cannot separately measure the measurement object 208a or 208b and the conveyance unit 702.

Hence, in this embodiment, the distance of the measurement object 208a or 208b is obtained based on the spectrum of light detected by a second detection unit 212. Only when the distance is equal to or less than a preset distance (or equal to or more than the distance), the velocity of the measurement object 208 is obtained. In addition, a processing unit 211 counts the number of times that the distance of the measurement object 208a or 208b becomes equal to or less than the preset distance. In this embodiment, the number of times that the distance of the measurement object 208a or 208b becomes equal to or less than the preset distance is counted by the processing unit 211. However, the number of times may be counted by an external information processing apparatus.

According to this embodiment, it is possible to reduce the measurement count of the velocity of the measurement objects 208a and 208b by the measurement apparatus MA and also separately measure the measurement object 208a or 208b and the conveyance unit 702. It is also possible to count the number of measurement objects by classifying the types of measurement objects in accordance with the heights and measuring the lengths while conveying the measurement objects having different heights. Furthermore, when the distance of the measurement object 208a or 208b is equal to or more than a preset distance, the velocity of the conveyance unit 702 is obtained, thereby measuring the distance (interval) between the measurement object 208a and the measurement object 208b.

### Eighth Embodiment

In this embodiment, when manufacturing a product (a steel pipe or food) whose width or height changes depending on the feeding velocity, the length is measured while measuring the fluctuation in the width or height (distance) of the product (measurement object). Then, feedback control of the feeding velocity is performed based on the measured width or height of the product, thereby maintaining a constant width or height of the product.

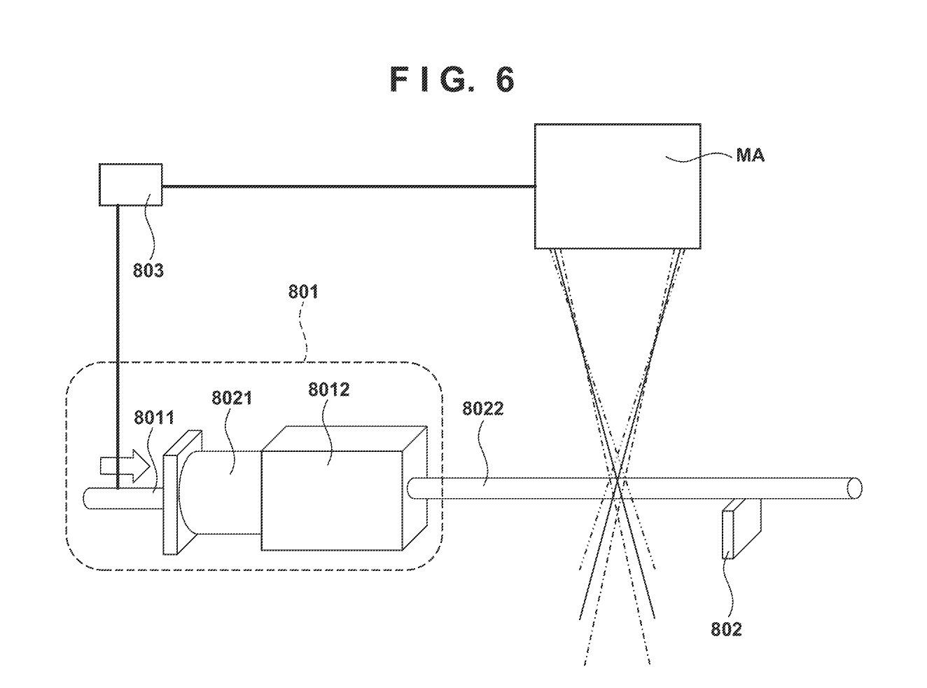

A manufacturing apparatus 801 for manufacturing a pipe 8022 (measurement object) made of a metal will be described below as a detailed example with reference to FIG. 6. A product (work) such as the pipe 8022 made of a metal is manufactured while controlling its width and thickness by extruding a wide metal tube 8021 into a molding unit 8012 by an extrusion unit 8011. The pipe 8022 made of a metal is held by a holding portion 802. Since the manufacturing apparatus 801 exists in the environment of a general factory, the ambient temperature fluctuates depending on the season or weather. When the ambient temperature fluctuates, the ductility of a metal also changes. Hence, to manufacture the pipe 8022 while maintaining even quality, the manufacturing cost increases.

Here, in this embodiment, the width and length of the pipe 8022 manufactured by the manufacturing apparatus 801 is measured by a measurement apparatus MA. Then, based on the width and length of the pipe 8022 measured by the measurement apparatus MA, a control unit 803 feedback-controls the extrusion velocity when the tube 8021 is extruded by the extrusion unit 8011. This makes it possible to reduce the manufacturing loss of the pipe 8022 and maintain predetermined quality.

Note that the manufacturing apparatus 801 can also be considered as a driving apparatus for driving (conveying) the pipe 8022 as a measurement object. The driving apparatus that includes the measurement apparatus MA and the control unit (control unit 803) configured to control the velocity (extrusion velocity) of the measurement object (pipe 8022) in the moving direction and drives (conveys) the measurement object also constitutes an aspect of the present invention. The control unit controls the velocity of the measurement object such that the distance of the measurement object (the width of the pipe 8022) measured by the measurement apparatus MA falls within a predetermined distance range.

### Ninth Embodiment

In this embodiment, the relative positions of a measurement object and a measurement apparatus MA are controlled such that the first light and the second light of light having a wavelength (the wavelength with large scattering on the measurement object) that maximizes the intensity of light from the measurement object in a plurality of lights with which the measurement object is irradiated overlap on the measurement object.

Because of the surface structure or absorption of the measurement object, reflection or scattering on the measurement object has a wavelength-dependent characteristic. To measure the velocity of the measurement object, the measurement apparatus MA detects light (scattered light) directed to the space between the first light and the second light of light from the measurement object, as described above. Hence, the relative positions of the measurement object and the measurement apparatus MA are preferably controlled such that the measurement object is arranged at a position where the first light and the second light of light having a wavelength that maximizes the intensity of light from the measurement object overlap. This allows a first detection unit 210 to detect more light from the measurement object, and the S/N ratio of a signal representing the intensity of the light detected by the first detection unit 210 can be improved.

### 10th Embodiment

In this embodiment, in a measurement apparatus MA shown in FIG. 2, some of lights from a measurement object 208, which are not divided by a light division unit 204, are extracted by a beam splitter and detected by one photodetector. In addition, control is performed such that light emission from a first light source 2011, a second light source 2012, and a third light source 2013 is sequentially performed at different times, and this cycle is repeated. For example, the first light source 2011, the second light source 2012, and the third light source 2013 repetitively emit lights in this order at an interval of 500 μs. Additionally, the wavelength of light detected by the photodetector is identified in synchronism with the timing to emit light from each of the first light source 2011, the second light source 2012, and the third light source 2013. This can decrease the number of photodetectors and contribute to size reduction and cost reduction of the measurement apparatus MA.

### 11th Embodiment

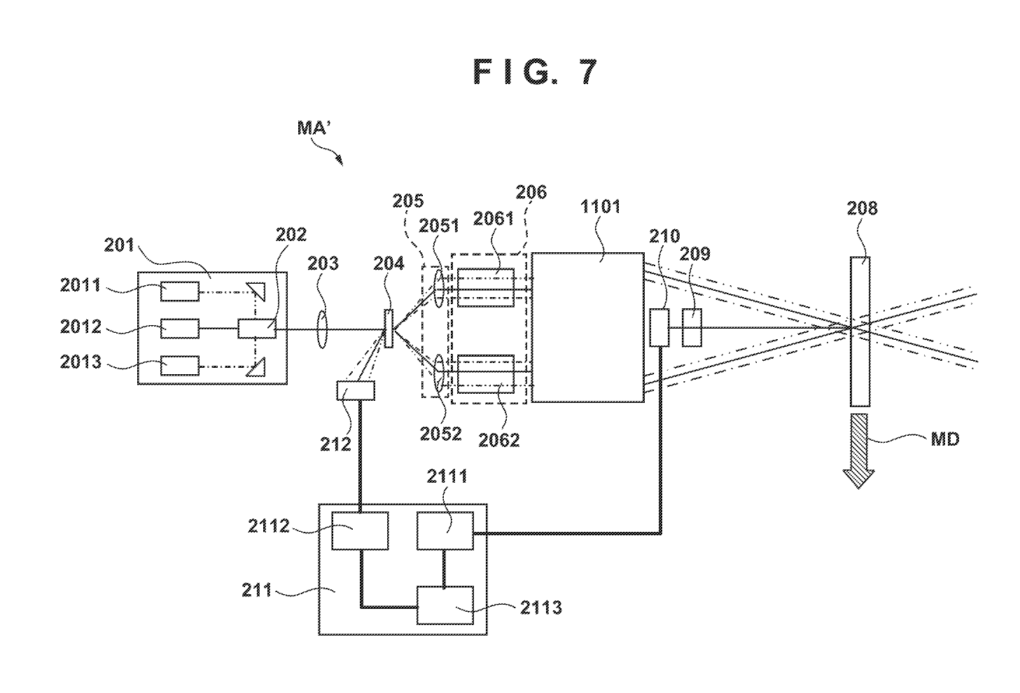

FIG. 7 is a schematic view showing the arrangement of a measurement apparatus MA′ according to the 11th embodiment. The measurement apparatus MA′ measures the displacement of a measurement object 208 in a moving direction MD. The measurement apparatus MA′ is different from the measurement apparatus MA in that it includes an irradiation optical system 1101 in place of the irradiation optical system 207. Components other than the irradiation optical system are the same as in the first embodiment.

The irradiation optical system 1101 irradiates the measurement object 208 with a plurality of lights such that first light and second light overlap to form an interference fringe at different positions in the moving direction MD in correspondence with the wavelengths of the plurality of lights emitted from a light source unit 201. However, in a direction (distance direction) orthogonal to the moving direction MD of the measurement object 208, the distance between the position where the first light and the second light overlap and the irradiation optical system 1101 (measurement apparatus MA′) does not change regardless of the wavelength of light. If the measurement object 208 is, for example, a cable having a string shape, the wavelength of light reflected by the measurement object 208 changes depending on the waviness in the moving direction MD. In this embodiment, it is possible to measure the displacement of the measurement object 208 in the moving direction MD and accurately obtain the length of the measurement object 208 even in such a case.

Furthermore, as described above, a driving apparatus that includes the measurement apparatus MA′ for measuring the displacement of the measurement object 208 in the moving direction MD and a control unit configured to control the displacement of the measurement object 208 such that the displacement amount of the measurement object 208 in the moving direction falls within a predetermined range also constitutes an aspect of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-211936 filed on Nov. 1, 2017, which is hereby incorporated by reference herein in its entirety.

What is claimed is:

1. A measurement apparatus for measuring a velocity of a measurement object in a moving direction, comprising:
an optical system configured to divide each of lights emitted from a light source unit into first light and second light and irradiate the measurement object with the lights such that the first light and the second light overlap to form an interference fringe at different positions in a direction orthogonal to the moving direction in correspondence with wavelengths of the lights, wherein a first wavelength of the first light is different from a second wavelength of the second light;
a first detection unit configured to detect the light from the measurement object; and
a processing unit configured to obtain the velocity based on a change in an intensity of the light detected by the first detection unit.

2. The apparatus according to claim 1, wherein the optical system irradiates the measurement object with the lights such that, of overlap regions of the first lights and the second lights of the lights, parts of adjacent regions overlap in the direction orthogonal to the moving direction.

3. The apparatus according to claim 1, wherein letting λᵢ be a wavelength of ith light of the lights, ϕᵢ be an irradiation angle of the ith light with which the measurement object is irradiated, and a be a constant, the optical system irradiates the measurement object with the lights to satisfy
$$\frac{{λ}_{i}}{sin {ϕ}_{i}} = a \qquad$$

4. The apparatus according to claim 1, further comprising a second detection unit configured to detect light that passes through an optical path of one of the first light and the second light in the lights from the measurement object,
wherein the processing unit obtains a distance between the measurement apparatus and the measurement object in the direction orthogonal to the moving direction based on a spectrum of the light detected by the second detection unit.

5. The apparatus according to claim 4, wherein the processing unit obtains a peak wavelength by normalizing the spectrum of the light detected by the second detection unit based on spectra of the lights emitted from the light source unit and a spectrum loss characteristic in an optical path from the light source unit to the second detection unit.

6. The apparatus according to claim 4, wherein the processing unit obtains a peak wavelength by normalizing the spectrum of the light detected by the second detection unit based on a reflectance characteristic of the measurement object.

7. The apparatus according to claim 4, wherein the processing unit obtains a displacement of the measurement object in the moving direction based on a change in an intensity of a peak wavelength of the spectrum of the light detected by the second detection unit.

8. The apparatus according to claim 4, wherein the processing unit obtains the velocity when the distance becomes a predetermined distance.

9. The apparatus according to claim 1, further comprising a second detection unit configured to detect light that passes through an optical path of one of the first light and the second light in the lights from the measurement object,
wherein letting λᵢ be a wavelength of ith light of the lights, ϕᵢ be an irradiation angle of the ith light with which the measurement object is irradiated, and b(λᵢ) be a value depending on the wavelength λᵢ, the processing unit corrects the velocity obtained based on a change in the intensity of the light detected by the first detection unit, based on a relational expression given by
$$\frac{{λ}_{i}}{sin {ϕ}_{i}} = b ( {λ}_{i} )$$
and the spectrum of the light detected by the second detection unit.

10. A driving apparatus for driving a measurement object, comprising:
a measurement apparatus configured to measure a velocity of the measurement object in a moving direction; and
a control unit configured to control the velocity of the measurement object in the moving direction,
wherein the measurement apparatus comprises:
an optical system configured to divide each of lights emitted from a light source unit into first light and second light and irradiate the measurement object with the lights such that the first light and the second light overlap to form an interference fringe at different positions in a direction orthogonal to the moving direction in correspondence with wavelengths of the lights, wherein a first wavelength of the first light is different from a second wavelength of the second light;
a first detection unit configured to detect the light from the measurement object;
a second detection unit configured to detect light that passes through an optical path of one of the first light and the second light in the lights from the measurement object; and
a processing unit configured to obtain the velocity based on a change in an intensity of the light detected by the first detection unit and obtain a distance between the measurement apparatus and the measurement object in the direction orthogonal to the moving direction based on a spectrum of the light detected by the second detection unit, and
the control unit controls the velocity of the measurement object in the moving direction such that the distance obtained by the processing unit falls within a predetermined distance range.

11. The apparatus according to claim 10, wherein the control unit controls relative positions of the measurement object and the measurement apparatus in the direction orthogonal to the moving direction such that the first light and the second light of light having a wavelength that maximizes the intensity of the light from the measurement object in the lights overlap on the measurement object.

12. A measurement apparatus comprising:
an optical system configured to divide each of lights emitted from a light source unit into first light and second light and irradiate the measurement object with the lights such that the first light and the second light overlap to form an interference fringe at different positions in the moving direction of the measurement object in correspondence with wavelengths of the lights, wherein a first wavelength of the first light is different from a second wavelength of the second light;
a detection unit configured to detect light that passes through an optical path of one of the first light and the second light in the lights from the measurement object; and
a processing unit configured to obtain a displacement of the measurement object in the moving direction based on a peak wavelength of a spectrum of the light detected by the detection unit.

13. A driving apparatus for driving a measurement object, comprising:
a measurement apparatus configured to measure a displacement of the measurement object in a moving direction; and
a control unit configured to control the displacement of the measurement object such that a displacement amount of the measurement object in the moving direction falls within a predetermined range,
wherein the measurement apparatus comprises:
an optical system configured to divide each of lights emitted from a light source unit into first light and second light and irradiate the measurement object with the lights such that the first light and the second light overlap to form an interference fringe at different positions in the moving direction of the measurement object in correspondence with wavelengths of the lights, wherein a first wavelength of the first light is different from a second wavelength of the second light;
a detection unit configured to detect light that passes through an optical path of one of the first light and the second light in the lights from the measurement object; and
a processing unit configured to obtain the displacement of the measurement object in the moving direction based on a peak wavelength of a spectrum of the light detected by the detection unit.
